(19) United States
(12) Patent Application Publication
(10) Pub. No.: US 2025/0181288 A1
(43) Pub. Date: Jun. 5, 2025

(54) PRINTING APPARATUS, PRINTING METHOD, AND MEDIUM

(71) Applicant: BROTHER KOGYO KABUSHIKI KAISHA, Nagoya (JP)

(72) Inventor: Katsunori SAKAI, Toyokawa (JP)

(73) Assignee: BROTHER KOGYO KABUSHIKI KAISHA, Nagoya (JP)

(21) Appl. No.: 18/953,613

(22) Filed: Nov. 20, 2024

(30) Foreign Application Priority Data
Dec. 1, 2023 (JP) 2023-204153

(51) Int. Cl. G06F 3/12

(52) U.S. Cl. CPC G06F 3/1236; G06F 3/1203; G06F 3/1281

(57) ABSTRACT

There is provided a printing apparatus including: a main control circuit; and sub-control circuits connected in series to each other and configured to transmit print data, the sub-control circuits including at least a downstream-most sub-control circuit and an upstream-most sub-control circuit connected to the main control circuit. Each of at least one sub-control circuit, included in the sub-control circuits and other than the downstream-most sub-control circuit is configured to: store information indicating one of transmitting methods of the print data, the transmitting methods including a transmitting method by which the one of the sub-control circuits having received the print data transmits entirety of the print data received downstream; and transmit the print data downstream, by the one of the transmitting methods indicated by the information, in a case where the print data is received.

### REFERENCE TO RELATED APPLICATIONS

This application claims priority from Japanese Patent Application No. 2023-204153 filed on Dec. 1, 2023. The entire content of the priority application is incorporated herein by reference.

### BACKGROUND ART

A liquid droplet ejecting apparatus has been proposed including a plurality of head substrates which drives a head, and a plurality of head control substrates which controls the plurality of head substrates. The plurality of head control substrates is daisy-chained. A main controller transmits image data to a head control substrate which is located at an end on the upstream side. Each of the plurality of head control substrates transmits the print data to the downstream side, and controls one of the plurality of the head substrates.

### SUMMARY

In the liquid droplet ejecting apparatus described above, in a case where each of the plurality of head control substrates receives the image data from the upstream side, each of the plurality of head control substrates saves image data which corresponds to the self and transmits image data which does not correspond to the self downstream. In a case where the efficiency of a transmitting process of the image data decreases, there is such a fear that printing might take a long time.

The present disclosure has been made in view of the above-described situation, and an object of the present disclosure is to provide a printing apparatus, a printing method and a medium each capable of suppressing a decrease in efficiency of a transmitting process of image data.

According to a first aspect of the present disclosure, there is provided a printing apparatus including:
a main control circuit; and
a plurality of sub-control circuits which is connected in series to each other and which is configured to transmit print data transmitted from the main control circuit downstream, the plurality of sub-control circuits including at least a downstream-most sub-control circuit positioned on a downstream-most side among the plurality of sub-control circuits and an upstream-most sub-control circuit positioned on an upstream-most side among the plurality of sub-control circuits and connected to the main control circuit,
wherein each of at least one sub-control circuit, which is included in the plurality of sub-control circuits and which is other than the downstream-most sub-control circuit is configured to:
   store information indicating one of a plurality of transmitting methods of the print data, the plurality of transmitting methods including a transmitting method by which the one of the plurality of sub-control circuits having received the print data transmits entirety of the print data received downstream; and
   transmit the print data downstream, by the one of the plurality of transmitting methods indicated by the information, in a case where the print data is received.

According to a second aspect of the present disclosure, there is provided a printing method executed in a printing apparatus,
the printing apparatus including:
   a main control circuit; and
   a plurality of sub-control circuits which is connected in series to each other and which is configured to transmit print data transmitted from the main control circuit downstream, the plurality of sub-control circuits including at least a downstream-most sub-control circuit positioned on a downstream-most side among the plurality of sub-control circuits and an upstream-most sub-control circuit positioned on an upstream-most side among the plurality of sub-control circuits and connected to the main control circuit;
the printing method including causing each of at least one sub-control circuit, which is included in the plurality of sub-control circuits and which is other than the downstream-most sub-control circuit to:
store information indicating one of the plurality of transmitting methods of the print data, the plurality of transmitting methods including a transmitting method by which the one of the plurality of sub-control circuits having received the print data transmits entirety of the print data received downstream; and
transmit the print data downstream, by the one of the plurality of transmitting methods indicated by the information, in a case where the print data is received.

According to a third aspect of the present disclosure, there is provided a non-transitory and computer-readable medium storing a program executable by a plurality of sub-control circuits of a printing apparatus,
the printing apparatus including:
   a main control circuit; and
   the plurality of sub-control circuits which is connected in series to each other and which is configured to transmit print data transmitted from the main control circuit downstream, the plurality of sub-control circuits including at least a downstream-most sub-control circuit positioned on a downstream-most side among the plurality of sub-control circuits and an upstream-most sub-control circuit positioned on an upstream-most side among the plurality of sub-control circuits and connected to the main control circuit;
the program is configured to cause each of at least one sub-control circuit, which is included in the plurality of sub-control circuits and which is other than the downstream-most sub-control circuit to execute:
storing of information indicating one of a plurality of transmitting methods of the print data, the plurality of transmitting methods including a transmitting method by which the one of the plurality of sub-control circuits having received the print data transmits entirety of the print data received downstream; and
transmitting of the print data downstream, by the one of the plurality of transmitting methods indicated by the information, in a case where the print data is received.

In the printing apparatus, the printing method, and the medium each according to an embodiment of the present disclosure, information indicating a transmitting method of a print data is stored; in a case where the print data is received, the print data is transmitted downstream according to the transmitting method indicated by the information. For example, in a case where the information indicates a method of transmitting the print data without storing the print data and where a sub-control circuit receives the print data from an upstream side, the sub-control circuit transmits the print data downstream, without storing the print data in a memory of the self, thereby suppressing a decrease in efficiency of a transmitting process of the print data.

### BRIEF DESCRIPTION OF DRAWINGS

FIG. 1 is a schematic plan view of a printing apparatus.

FIG. 2 is a plan perspective view of an ink-jet head.

FIG. 3 is a block diagram of a controller and the ink-jet head.

FIG. 4 is a conceptual diagram depicting a memory area of a sub-control circuit.

FIG. 5 is a conceptual diagram depicting a memory area of an upstream-most sub-control circuit in a case where the upstream-most sub-control circuit receives print data of the first line.

FIG. 6 is a conceptual diagram depicting a memory area of a sub-control circuits other than the upstream-most sub-control circuit and a downstream-most sub-control circuit in a case where the sub-control circuit receives the print data of the first line.

FIG. 7 is a conceptual diagram depicting a memory area of the downstream-most sub-control circuit in a case where the downstream-most sub-control circuit receives the print data of the first line.

FIG. 8 is a conceptual diagram depicting the memory area of the upstream-most sub-control circuit in a case where the upstream-most sub-control circuit receives print data of the second line.

FIG. 9 is a flowchart illustrating a data transmitting process by a main control circuit.

FIG. 10 is a flowchart illustrating the data transmitting process by a control part of each of the sub-control circuits other than the downstream-most sub-control circuit.

FIG. 11 is a flowchart illustrating the data transmitting process by a control part of the downstream-most sub-control circuit.

FIG. 12 is a flowchart illustrating a printing process by a control part of the main control circuit.

FIG. 13 is a flowchart illustrating a data transmitting process by the main control circuit.

FIG. 14 is a flowchart illustrating the data transmitting process by the control part of each of the sub-control circuits other than the downstream-most sub-control circuit.

FIG. 15 is a flowchart illustrating a data transmitting process by the main control circuit.

FIG. 16 is a flowchart illustrating the data transmitting process by the control part of each of the sub-control circuits other than the downstream-most sub-control circuit.

FIG. 17 is a flowchart illustrating a data transmitting process by the main control circuit.

### DESCRIPTION

### Embodiment

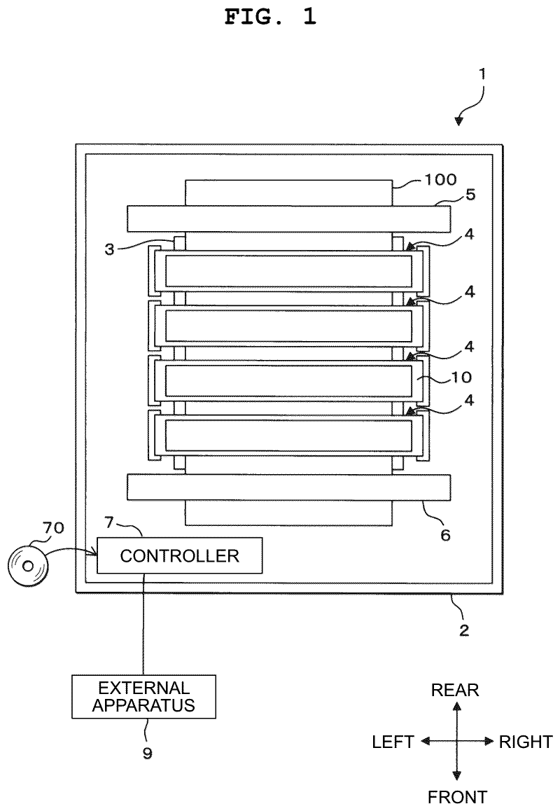

The present disclosure will be described below based on the drawings depicting a printing apparatus 1 according to a first embodiment. FIG. 1 is a schematic plan view of the printing apparatus 1. In FIG. 1, the conveying direction of a recording sheet 100 corresponds to the front-rear direction of the printing apparatus 1. Further, the width direction of the recording sheet 100 corresponds to the left-right direction of the printing apparatus 1. The recording sheet 100 corresponds to a recording medium. Furthermore, the direction orthogonal to the front-rear direction and the left-right direction, i.e., the direction perpendicular to the sheet surface of FIG. 1, corresponds to the up-down direction of the printing apparatus 1.

As depicted in FIG. 1, the printing apparatus 1 includes a case 2, and a platen 3, four ink-jet heads 4, two conveying rollers 5 and 6, a controller 7, etc., which are accommodated inside the case 2. The recording sheet 100 passes over the upper surface of the platen 3. Four ink-jet heads 4 are disposed side by side in the conveying direction and above the platen 3. Each of the four ink-jet heads 4 is a so-called head of the line type. An ink is supplied to each of the four ink-jet heads 4 from an ink tank (not depicted in the drawings). Inks of different colors are supplied, respectively, to the four ink-jet heads 4.

As depicted in FIG. 1, the two conveying rollers 5 and 6 are disposed on the rear and front sides, respectively, of the platen 3. The two conveying rollers 5 and 6 are each driven by a non-illustrated motor, and convey the recording sheet 100 on the platen 3 forward. The two conveying rollers 5 and 6 correspond to a “conveyor”. The controller 7 controls the printing apparatus 1 based on a control program. The controller 7 is connected to an external apparatus 9 such as a PC so as to be able to perform data communication with the external apparatus 9, and drives the respective parts of the printing apparatus 1 based on print data transmitted from the external apparatus 9 to execute printing.

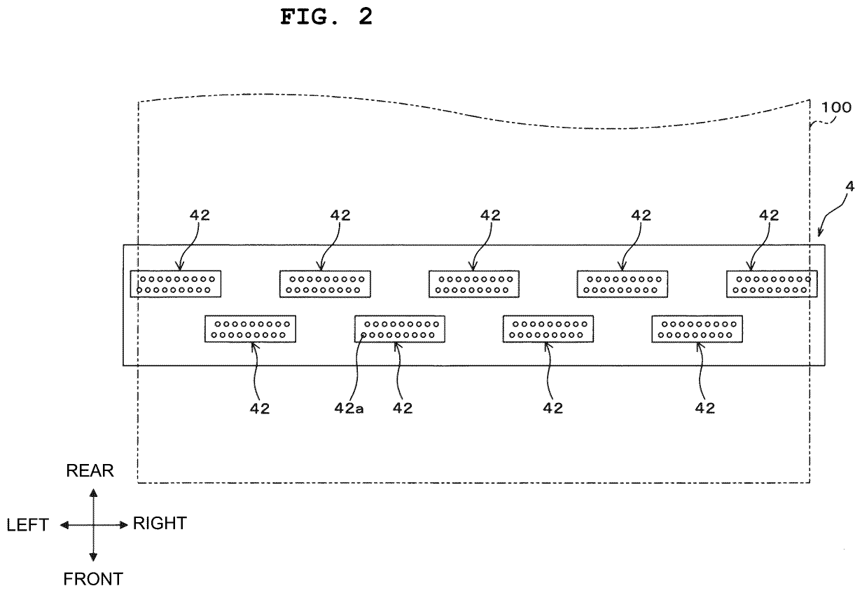

FIG. 2 is a plan perspective view of the ink-jet head 4. The ink-jet head 4 includes a plurality of heads 42. The head 42 corresponds to a head unit. The plurality of heads 42 are disposed in two rows in the front-rear direction. In a front row, four heads 42 are disposed along the left-right direction, and in a rear row, five heads 42 are disposed along the left-right direction. A plurality of nozzles 42a is disposed in the lower surface of the head 42. Note that the number of the heads 42 and the number of the rows of the heads 42 are not limited and can be changed.

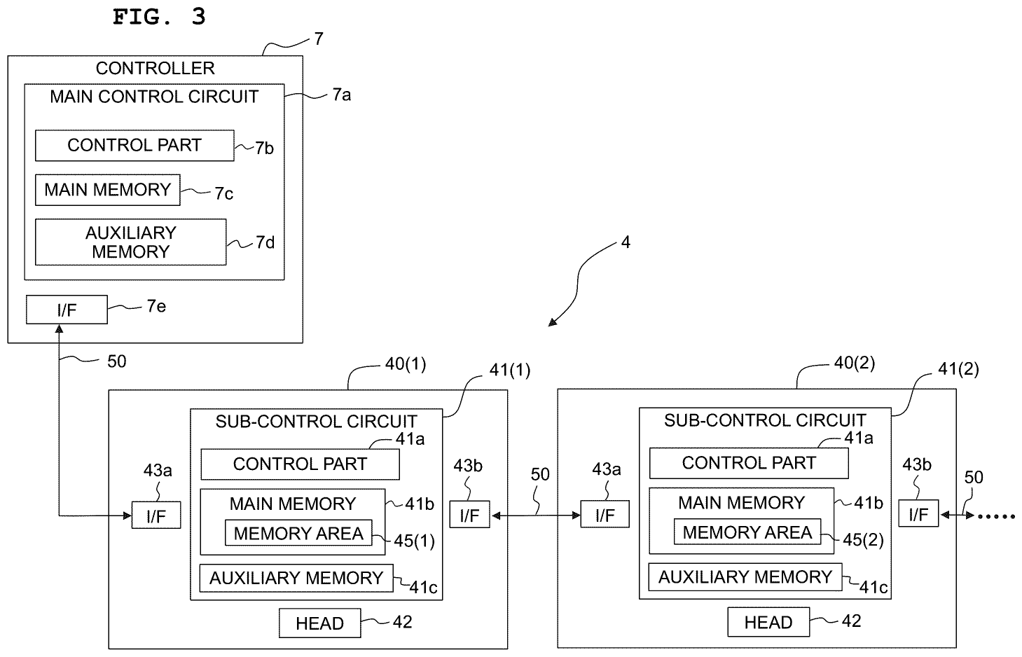

FIG. 3 is a block diagram of the controller 7 and the ink-jet head 4. The controller 7 includes a main control circuit 7a. The main control circuit 7a includes a control part 7b, a main memory 7c, an auxiliary memory 7d, and a communication interface (I/F) 7e. The control part 7b includes a logic circuit such as an FPGA or an ASIC, etc. Note that the control part 7b may include a processor such as a CPU, an MPU, or a GPU, etc.

The main memory 7c may be exemplified by a RAM. The auxiliary memory 7d may be exemplified by a ROM and a rewritable recording medium, such as an EEPROM, an EPROM, or a hard disk, etc. The auxiliary memory 7d stores a control program, a capacity of prescribed size which is to be described later, and the like. The control part 7b reads the control program from, for example, the auxiliary memory 7d to the main memory 7c and executes the control program. The control program may be installed in the auxiliary memory 7d from a recording medium 70 (see FIG. 1) which is, for example, an optical disk or a portable flash memory. Note that the control program may be downloaded to the auxiliary memory 7d from a server connected to the printing apparatus 1 via a communication network. The communication I/F 7e is connected to a communication cable 50. The controller 7 controls the printing apparatus 1 based on the control program.

The ink-jet head 4 includes a plurality of head modules 40. The plurality of head modules 40 is arranged in a row, for example, in the left-right direction. The plurality of head modules 40 includes, for example, a first head module 40(1), a second head module 40(2), . . . , an nth head module 40(n), . . . , and an Nth head module 40(N) (n is a natural number from 1 to N). The first head module 40(1) is positioned leftmost, and the Nth head module 40(N) is positioned rightmost. In the present embodiment, N is 9 (N=9). The first head module 40(1) is disposed at a position closest to the controller 7 among all the head modules 40, and the Nth head module 40(N) is disposed at a position farthest from the controller 7 among all the head modules 40.

Each of the first head module 40(1) to the Nth head module 40(N) includes a sub-control circuit 41, a head 42, an upstream-side I/F 43a, and a downstream-side I/F 43b. The plurality of heads 42 corresponds to a head group. The sub-control circuit 41 includes a control part 41a, a main memory 41b, and an auxiliary memory 41c. The sub-control circuit 41 includes, for example, an ASIC or SoC. A plurality of sub-control circuits 41 corresponds to a sub-control circuit group.

The control part 41a controls the operation of the sub-control circuit 41. The control part 41a may include a processor such as a CPU, etc., or may include a logic circuit such as an FPGA, etc. The main memory 41b is, for example, a RAM. The main memory 41b includes a memory area 45.

The auxiliary memory 41c is, for example, a rewritable and non-volatile memory such as a flash ROM or an EEPROM, etc. In the following, the sub-control circuits 41, respectively, of the first head module 40(1) to the Nth head module 40(N) are also referred to, respectively, as sub-control circuit 41(1) to sub-control circuit 40(N), and the memory areas 45, respectively, of the first head module 40(1) to the Nth head module 40(N) are also referred to, respectively, as memory area 45(1) to memory area 45(N). The sub-control circuit 41(1) is an example of an “upstream-most sub-control circuit”, and the sub-control circuit 41(N) is an example of a “downstream-most sub-control circuit”. Each of the sub-control circuits 42(2) to 42(8) is an example of an “intermediate sub-control circuit”.

Each of the I/F 7e, the I/F 43a, and the I/F 43b is an interface capable of two-way communication, and the I/F 7e, the I/Fs 43a, and the I/Fs 43b are connected in series by a connector and the communication cable 50. The I/F 7e transmits the print data to the I/F 43a of the sub-control circuit 41(1). The I/F 43b of the sub-control circuit 41(1) transfers the print data to the I/F 43a of the sub-control circuit 41(2), and the I/F 43b of the sub-control circuit 41(2) transmits the print data to the I/F 43a of the sub-control circuit 41(3). In this way, the print data is transferred in order down to the I/F 43a of the sub-control circuit 41(N). Each of the sub-control circuit 41(1) to the sub-control circuit 41(N) drives the head 42 based on the print data so as to eject the ink.

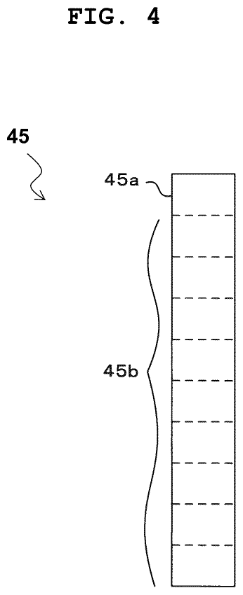

FIG. 4 is a conceptual diagram depicting the memory area 45 of the sub-control circuit 41. The memory area 45 includes a first memory area 45a configured to store information (data) indicating a transmitting method of the print data, and a second memory area 45b configured to store the print data.

The transmitting method of the print data includes, for example, a first transmitting method in which, in a case where a kth sub-control circuit (k is a natural number from 1 to N−1) receives the print data, the kth sub-control circuit stores kth data included in the received print data and transmits remaining print data excluding the kth data to the downstream side, and a second transmitting method in which, in the case where the kth sub-control circuit (k is a natural number from 1 to N−1) receives the print data, the kth sub-control circuit transmits the entirety of the received print data to the downstream side as it is. For example, the information indicating the first transmitting method is “0”, and the information indicating the second transmitting method is “1”. In a case where “0” is stored in the first memory area 45a, the sub-control circuit 41 transmits the print data to the downstream side by the first transmitting method, and in a case where “1” is stored in the first memory area 45a, the sub-control circuit 41 transmits the print data to the downstream side by the second transmitting method.

The main control circuit 7a transmits print data of a plurality of lines to the sub-control circuit 41(1) sequentially line by line. The main control circuit 7a divides the print data of one line into a plurality of data units, i.e., generates a plurality of data units from the print data of one line, and transmits each of the plurality of data units in sequence to the sub-control circuit 41(1). In other words, the print data of one line has the plurality of data units, and the main control circuit 7a transmits each of the plurality of data units in sequence to the sub-control circuit 41(1). Note that a dividing process of dividing the print data of one line into the plurality of data units is executed at an appropriate timing. For example, the main control circuit 7a may execute the dividing process all the time in a case where the main control circuit 7a has received the print data from the external apparatus 9; or such a configuration may be provided wherein the dividing process is not executed in a case where a size of a free space of the main memory 41b of each of the sub-control circuits 41 is a prescribed size or more, and wherein the dividing process is executed in a case where the size of the free space of the main memory 41b is less than the prescribed size.

In the present embodiment, the main control circuit 7a transmits print data of nine lines. In the initial state, the main control circuit 7a divides print data of one line into two data units. That is, the print data of one line includes a first data unit and a second data unit. In the initial state, a data amount of the first data unit is smaller than the seize of the free space of the second memory area 45b of the sub-control circuit 41(1), and a data amount of the second data unit is smaller than the size of the free space of the second memory area 45b of the sub-control circuit 41(1). Note that the main control circuit 7a may transmit print data of ten or more lines, or print data of eight or less lines. The main control circuit 7a may divide the print data of one line into three or more data units, or may make the print data of one line a single data unit, without dividing the print data of one line.

Further, in the present embodiment, the number of the sub-control circuits 41 is nine. That is, N is 9 (N=9). The first data unit includes data D1 to data D5 corresponding, respectively, to the sub-control circuit 41(1) to the sub-control circuit 41(5). The second data unit includes data D6 to data D9 corresponding, respectively, to the sub-control circuit 41(6) to the sub-control circuit 41(9). That is, the main control circuit 7a generates the first data unit and the second data unit.

The second data unit is a data unit generated from remaining print data, in which the generated data unit (first data unit) has been excluded from the print data of one line, and including data D6 which is the upstream-most data of the remaining print data. The data D1 corresponds to the first data. The data D6 corresponds to sth data.

After executing the transmitting process of the first data unit, i.e., the data D1 to the data D5, the main control circuit 7a executes the transmitting process of the second data unit, i.e., the data D6 to the data D9. In other words, the main control circuit 7a executes the transmitting process of transmitting the data D1 to the data D9, from the upstream side data among the data D1 to the data D9, to the sub-control circuit 41(1). Note that, in the transmitting process of transmitting the data D1 to the data D9, the main control circuit 7a may transmit the date D1 to the data D9 in any order. For example, the main control circuit 7a may transmit the data D1 to the data D9 starting from the downstream side data among the data D1 to the data D9. Note that the number of sub-control circuits 41 may be eight or less, or ten or more.

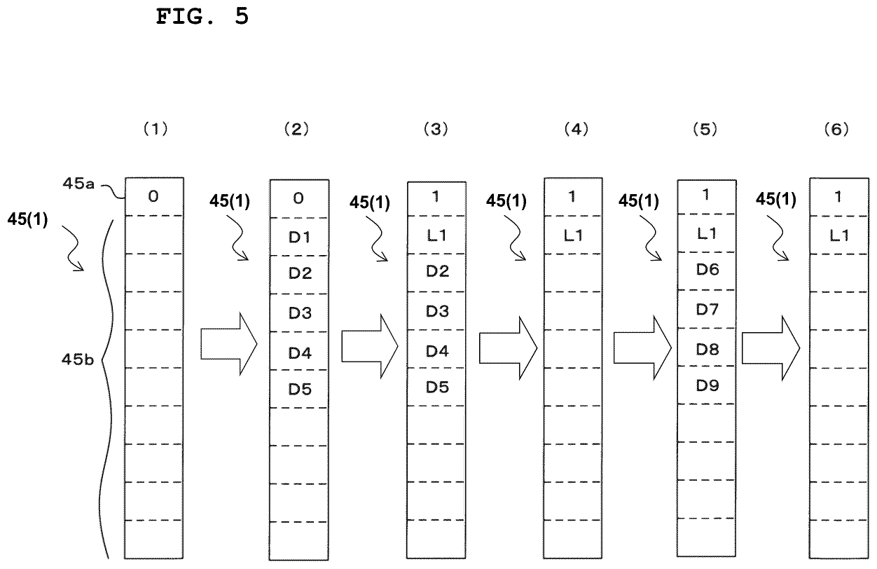

The transmitting process of the print data in each of the sub-control circuits 41 will now be described. FIG. 5 is a conceptual diagram depicting the memory area 45(1) of the upstream-most sub-control circuit 41(1) in a case where the upstream-most sub-control circuit 41(1) receives the print data of the first line. As depicted in (1) of FIG. 5, in the initial state, “0” is stored in the first memory area 45a of the memory area 45(1).

In a case where the sub-control circuit 41(1) receives the first data unit of the first line from the main control circuit 7a, the sub-control circuit 41(1) stores the data D1 to the data D5 in the second memory area 45b (see (2) in FIG. 5). Note that the size of the free space of the second memory area 45b is greater than the data amount of the first data unit. Since “0” is stored in the first memory area 45a, the sub-control circuit 41(1) saves the data D1 corresponding to the sub-control circuit 41(1) itself. In the following, data of a mth line which has been saved will also be referred to as data Lm (m=1 to 9) (the data Lm is an example of “corresponding data”). That is, the sub-control circuit 41(1) saves data L1. Further, the sub-control circuit 41(1) rewrites the information stored in the first memory area 45a. That is, the sub-control circuit 41(1) rewrites the information stored in the first memory area 45a from “0” to “1” (see (3) in FIG. 5).

The sub-control circuit 41(1) reads the data D2 to the data D5, which are the first data unit from which the data L1 has been excluded, i.e., the print data from which the data corresponding to the sub-control circuit 41(1) itself has been excluded, from the own second memory area 45b, transmits the data D2 to the data D5 to the downstream side, and deletes the data D2 to the data D5 from the second memory area 45b (see (4) in FIG. 5). In a case where the sub-control circuit 41(1) receives the second data unit of the first line from the main control circuit 7a, the sub-control circuit 41(1) stores the data D6 to the data D9 in the second memory area 45b (see (5) in FIG. 5). Note that the size of the free space of the second memory area 45b is greater than the data amount of the second data unit.

Since “1” is stored in the first memory area 45a, the sub-control circuit 41(1) transmits the entirety of the second data unit, i.e., the data D6 to the data D9, to the downstream side and deletes the data D6 to the data D9 from the second memory area 45b (see (6) in FIG. 5).

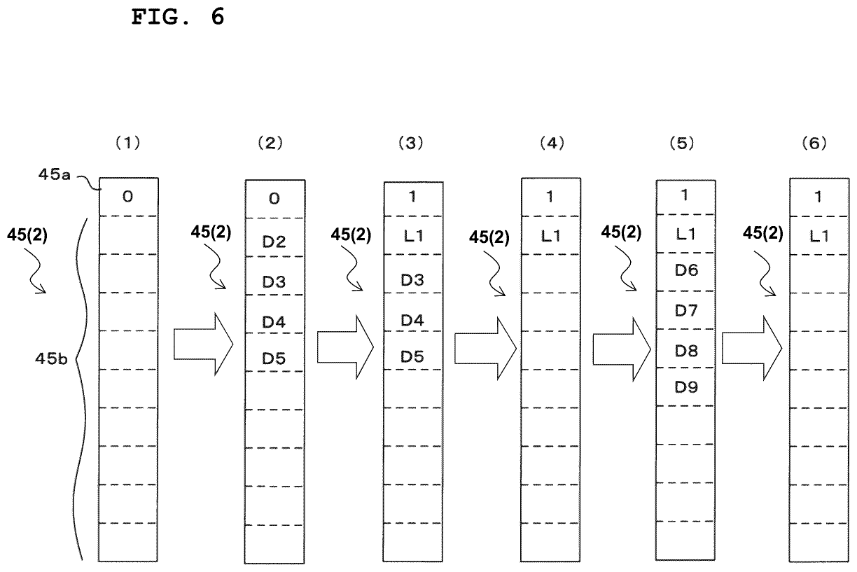

FIG. 6 is a conceptual diagram depicting the memory area 45 of the sub-control circuit 41 other than the upstream-most and downstream-most sub-control circuits 41 in a case where the sub-control circuit 41 receives the print data of the first line. Note that FIG. 6 depicts the memory area 45(2) of the sub-control circuit 41(2) positioned on the downstream side one stage from the upstream-most sub-control circuit 41(1), as an example of the memory area 45 of the sub-control circuits 41 other than the upstream-most and downstream-most sub-control circuits 41. As depicted in (1) in FIG. 6, in the initial state, “0” is stored in the first memory area 45a of the memory area 45(2).

In a case where the sub-control circuit 41(2) receives the first data unit of the first line from the sub-control circuit 41(1), the sub-control circuit 41(2) stores the data D2 to the data D5 in the second memory area 45b (see (2) in FIG. 6). Note that a size of a free space of the second memory area 45b is greater than the data amount of the first data unit.

Since “0” is stored in the first memory area 45a, the sub-control circuit 41(2) saves the data D2 of the first line corresponding to the sub-control circuit 41(2) itself, i.e., the data L1. Further, the sub-control circuit 41(2) rewrites the information stored in the first memory area 45a, i.e., rewrites the information stored in the first memory area 45a from “0” to “1” (see (3) in FIG. 6).

The sub-control circuit 41(2) reads the data D3 to the data D5 being print data from which the data L1 has been excluded, i.e., the print data from which the data corresponding to the sub-control circuit 41(2) itself has been excluded, from the own second memory area 45b, transmits the data D3 to the data D5 to the downstream side, and deletes the data D3 to the data D5 from the second memory area 45b (see (4) in FIG. 6). In a case where the sub-control circuit 41(2) receives the second data unit of the first line from the sub-control circuit 41(1), the sub-control circuit 41(2) stores the data D6 to the data D9 in the second memory area 45b (see (5) in FIG. 6). Note that the size of the free space of the second memory area 45b is greater than the data amount of the second data unit.

Since “1” is stored in the first memory area 45a, the sub-control circuit 41(2) transmits the entirety of the second data unit, i.e., the data D6 to the data D9, to the downstream side and deletes the data D6 to the data D9 from the second memory area 45b (see (6) in FIG. 6).

Similarly, each of the sub-control circuits 41(3) to 41(8) also saves the print data corresponding to the self and transmits the print data from which the data corresponding to the self has been excluded to the downstream side. Note that since the sub-control circuit 41(5) saves the data D5 and does not transmit the first data unit to the downstream side, each of the sub-control circuits 41(6) to 41(9) receives only the second data unit from the upstream side.

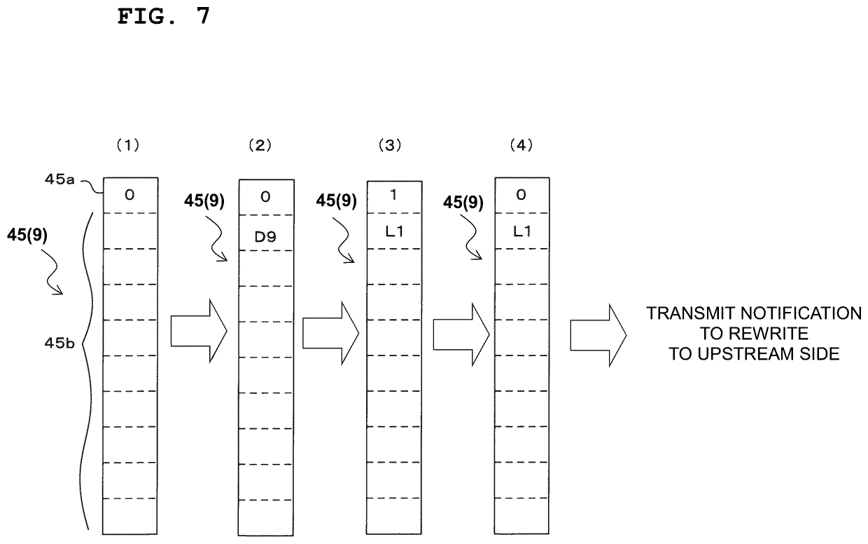

FIG. 7 is a conceptual diagram depicting the memory area 45(9) of the downstream-most sub-control circuit 41(9) in a case where the downstream-most sub-control circuit 41(9) receives the print data of the first line. As depicted in (1) in FIG. 7, in the initial state, “0” is stored in the first memory area 45a of the memory area 45(9). In a case where the sub-control circuit 41(9) receives the second data unit of the first line from the sub-control circuit 41(8), that is, in a case where the downstream-most sub-control circuit 41(9) receives the data D9, the downstream-most sub-control circuit 41(9) stores the data D9 in the second memory area 45b (see (2) in FIG. 7). Note that a size of a free space of the second memory area 45b is greater than the data amount of the second data unit.

Since “0” is stored in the first memory area 45a, the sub-control circuit 41(9) saves the data D9 of the first line corresponding to the self, i.e., the data L1. Further, the sub-control circuit 41(9) rewrites the information stored in the first memory area 45a. That is, the downstream-most sub-control circuit 41(9) rewrites the information stored in the first memory area 45a from “0” to “1” (see (3) in FIG. 7). The sub-control circuit 41(9) is the downstream-most sub-control circuit 41. Therefore, the downstream-most sub-control circuit 41(9) cannot transfer the print data downstream from the self.

The sub-control circuit 41(9) rewrites the information stored in the first memory area 45a. That is, the sub-control circuit 41(9) rewrites the information stored in the first memory area 45a from “1” to “0” (see (4) in FIG. 7) and transmits, to the upstream side, a notification indicating that the information stored in the first memory area 45a is to be rewritten. That is, the sub-control circuit 41(9) transmits a notification indicating that the information stored in the first memory area 45a of each of the sub-control circuits 41(1) to 41(8) is to be rewritten, namely, “1” is to be rewritten to “0”. In other words, in a case where the sub-control circuit 41 located downstream-most receives the print data corresponding to the self, the sub-control circuit 41 located downstream-most transmits, to the upstream side, the notification indicating that “1” which is the information indicating the second transmitting method is to be rewritten to “0” which is the information indicating the first transmitting method. Note that the sub-control circuit 41(9) may store “0”, save the data L1, and transmit the notification to the upstream side, without rewriting the information stored in the first memory area 45a.

Each of the sub-control circuits 41(8) to 41(1) transfers the received notification to the upstream side and rewrites “1” stored in the own first memory area 45a to “0”. The sub-control circuit 41(1), which is positioned most upstream among the plurality of sub-control circuits 41, transmits information (also referred to as “free space information”) indicating the size of the free space of the own second memory area 45b to the main control circuit 7a, together with the notification.

In a case where the main control circuit 7a receives the notification from the sub-control circuit 41(1), the main control circuit 7a transmits print data of the next line to the downstream side. In a case where the main control circuit 7a receives the notification, each of the sub-control circuits 41 has already saved the print data of one line. In other words, the reception of the notification in the main control circuit 7a indicates that the transmission of the print data of one line has been completed, and after the transmission of the print data of one line has been completed, the main control circuit 7a transmits the print data of the next line to the downstream side.

In a case where the size of the free space of the second memory area 45b of the sub-control circuit 41(1) is less than the prescribed size, the main control circuit 7a changes the data amount of each of the data units (first data unit and second data unit) so as not to exceed the size of the free space of the second memory area 45b, i.e., reduces the data amount, and transmits the print data of the next line to the downstream side. Examples of a method of making the data amount small include a method of dividing the data or a method of compressing the data.

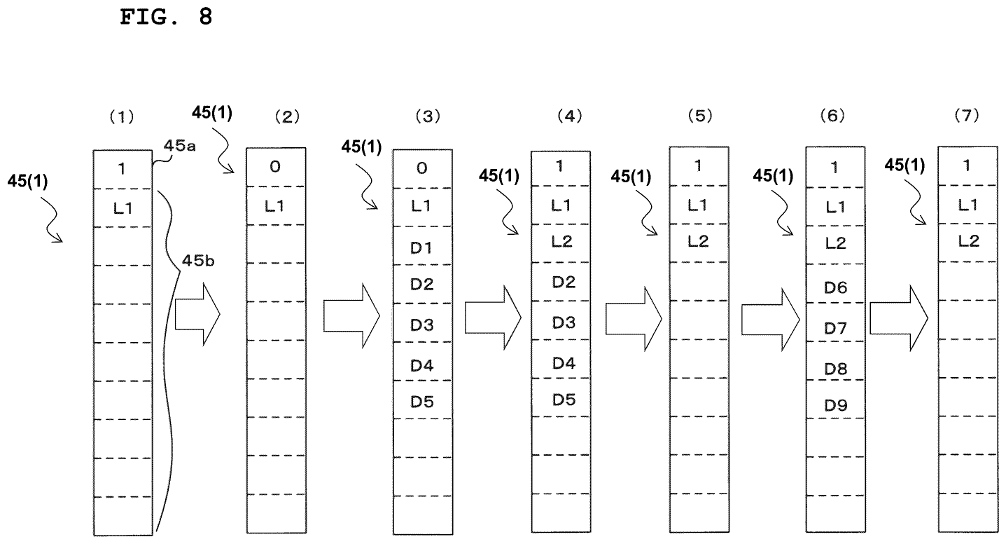

FIG. 8 is a conceptual diagram depicting the memory area 45(1) of the upstream-most sub-control circuit 41(1) in a case where the upstream-most sub-control circuit 41(1) receives the print data of the second line. After receiving the print data of the first line and before receiving the print data of the second line, the upstream-most sub-control circuit 41(1) stores “1” in the first memory area 45a and saves the data L1 in the second memory area 45b (see (1) in FIG. 8). In a case where the sub-control circuit 41(1) receives the notification from the sub-control circuit 41(2), that is, the notification indicating that the information stored in the first memory area 45a is to be rewritten, the upstream-most sub-control circuit 41(1) rewrites “1” in the first memory area 45a to “0” (see (2) in FIG. 8).

In a case where the sub-control circuit 41(1) receives the first data unit of the second line from the main control circuit 7a, the sub-control circuit 41(1) stores the data D1 to the data D5 in the second memory area 45b (see (3) in FIG. 8). Note that the size of the free space of the second memory area 45b is greater than the data amount of the first data unit.

Since “0” is stored in the first memory area 45a, the sub-control circuit 41(1) saves the data D1 of the second line corresponding to the self, i.e., data L2. Further, the sub-control circuit 41(1) rewrites the information stored in the first memory area 45a. That is, the sub-control circuit 41(1) rewrites the information stored in the first memory area 45a from “0” to “1” (see (4) in FIG. 8).

The sub-control circuit 41(1) transmits the data D2 to the data D5 being the first data unit from which the data L2 has been excluded, i.e., the print data from which the data corresponding to the sub-control circuit 41(1) itself has been excluded, to the downstream side and deletes the data D2 to the data D5 from the second memory area 45b (see (5) in FIG. 8). In a case where the sub-control circuit 41(1) receives the second data unit of the second line, i.e., the data D6 to the data D9, from the main control circuit 7a, the sub-control circuit 41(1) stores the data D6 to the data D9 in the second memory area 45b (see (6) in FIG. 8). Note that the size of the free space of the second memory area 45b is greater than the data amount of the second data unit.

Since “1” is stored in the first memory area 45a, the sub-control circuit 41(1) transmits the entirety of the second data unit, i.e., the data D6 to the data D9, to the downstream side and deletes the data D6 to the data D9 from the second memory area 45b (see (7) in FIG. 8).

In FIG. 5, the data D1 (data L1) is the print data corresponding to the sub-control circuit 41(1), and the data D2 to the data D9 are the print data from which the data D1 corresponding to the sub-control circuit 41(1) itself has been excluded. The second memory area 45b is a common memory area (same memory area) configured to store the data D1, and the data D2 to the data D9. That is, the sub-control circuit 41(1) has the common memory area configured to store the data D1 and the print data (the data D2 to the data D9) from which the data D1 has been excluded. Similarly, each of the sub-control circuits 41(2) to 41(9) has the common memory area (second memory area) configured to store print data corresponding to each of the sub-control circuits 41(2) to 41(9) itself and the print data from which the print data corresponding to each of the sub-control circuits 41(2) to 41(9) itself has been excluded.

The main control circuit 7a transmits the print data of all the lines as described above. Each of the sub-control circuits 41(2) to 41(9) saves the print data of the respective lines as described above. Each of the sub-control circuits 41(1) to 41(9) executes the printing at an appropriate timing for executing the printing, that is, a printing timing. For example, every time all the sub-control circuits 41(1) to 41(9) save print data of three lines, each of the sub-control circuits 41(1) to 41(9) reads out the print data corresponding to the self from the own second memory area 45b, transmits the print data corresponding to the self to the head 42, of the plurality of heads 42, corresponding to the self, and executes the printing. Note that as described above, each of the sub-control circuits 41(1) to 41(8) reads out, from the own second memory area 45b, the print data from which the print data corresponding to the self has been excluded, and transmits, to the downstream side, the print data from which the print data corresponding to the self has been excluded.

For example, in a case where the main control circuit 7a receives the notification indicating that “1” is to be rewritten to “0” transmitted from the downstream-most sub-control circuit 41(9) three times, the main control circuit 7a determines that all the sub-control circuits 41(1) to 41(9) have saved the print data of three lines, and transmits a print executing command to all of the sub-control circuits 41(1) to 41(9). Each of the sub-control circuits 41(1) to 41(9) which has received the print executing command executes the printing. Each of the sub-control circuits 41(1) to 41(9) deletes the print data for which the printing has been executed, i.e., the data Lm for which the printing has been executed, from the own second memory area 45b. Note that the printing timing is not limited to the case where all of the sub-control circuits 41(1) to 41(9) have saved the print data of three lines, and may be a case where all of the sub-control circuits 41(1) to 41(9) have saved the print data of one line, print data of two lines, or print data of four or more lines.

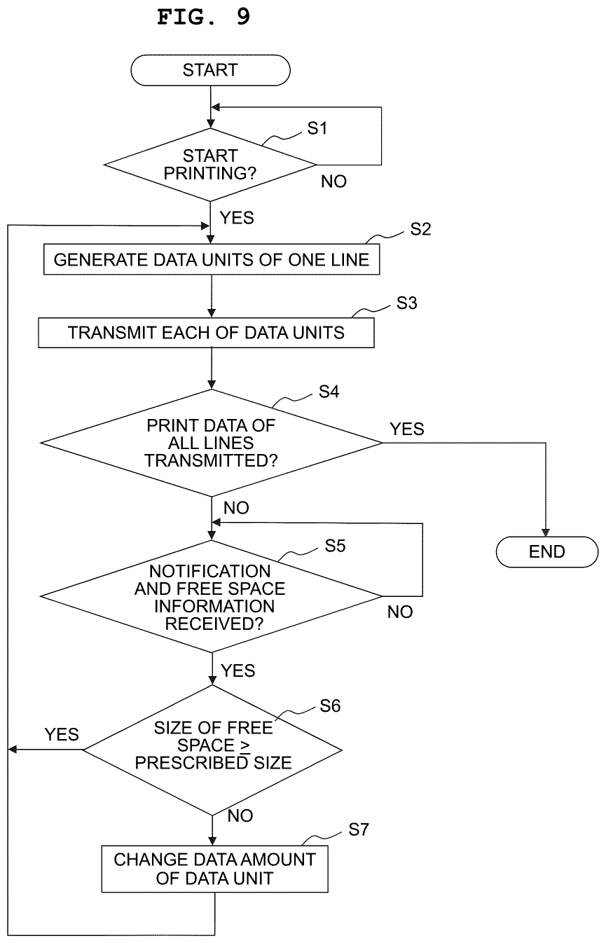

FIG. 9 is a flow chart illustrating a data transmitting process by the main control circuit 7a. The control part 7b of the main control circuit 7a determines whether a print start signal has been received (step S1). For example, a user operates a print start switch to thereby cause the print start signal to be input to the main control circuit 7a. In a case where the control part 7b determines that the print start signal has not been received (step S1: NO), the control part 7b returns the process to the step S1. In a case where the control part 7b determines that the print start signal is received (step S1: YES), the control part 7b generates the data unit(s) of one line, for example, the first data unit and the second data unit (step S2), and transmits each of the first and second data units in order (step S3). The control part 7b transmits the first data unit and then transmits the second data unit. Note that in the steps S2 and S3, the control part 7b may generate and transmit the second data unit after the control part 7b has generated and transmitted the first data unit.

The control part 7b determines whether the print data of all the lines have been transmitted (step S4). In a case where the control part 7b determines that the print data of all the lines have not been transmitted (step S4: NO), the control part 7b determines whether the notification indicating that the information stored in the first memory area 45a is to be rewritten from “1” to “0” and the information (free space information) indicating the size of the free space of the second memory area 45b of the sub-control circuit 41(1) have been received (step S5). In a case where the control part 7b determines that the notification and the free space information have not been received (step S5: NO), the control part 7b returns the process to the step S5.

In a case where the control part 7b has determined that the notification and the free space information have been received (step S5: YES), the control part 7b determines whether the size of the free space is the prescribed size or more (step S6). The prescribed size is, for example, a prescribed multiple of the data amount of the data unit. For example, the prescribed size is p times the data amount of the data unit. The “p” is a value greater than 1, and is, for example, 1.5 or more. The data amount of the data unit is the data amount of the data unit transmitted in the step S2, and in a case where a plurality of data units is transmitted, the prescribed size is the data amount of the maximum data unit among the plurality of data units.

In a case where the control part 7b determines that the size of the free space is the prescribed size or more (step S6: YES), the control part 7b returns the process to the step S2. In a case where the control part 7b determines that the size of the free space is not the prescribed size or more (step S6: NO), that is, in a case where the control part 7b determines that the size of the free space is less than the prescribed size, the control part 7b changes the data amount of the data unit so that the data amount of the data unit is smaller than the size of the free space of the second memory area 45b of the sub-control circuit 41(1) (step S7). For example, the control part 7b determines the data amount of the data unit (first data unit and second data unit) to be a value obtained by dividing the size of the free space by “q”. The “q” is a value greater than 1, and is, for example, 3 or more. The “q” may be any value by which the size of the free space is the prescribed size or more in step S6.

In the step S4, in a case where the control part 7b determines that the print data of all the lines have been transmitted (step S4: YES), the control part 7b ends the process.

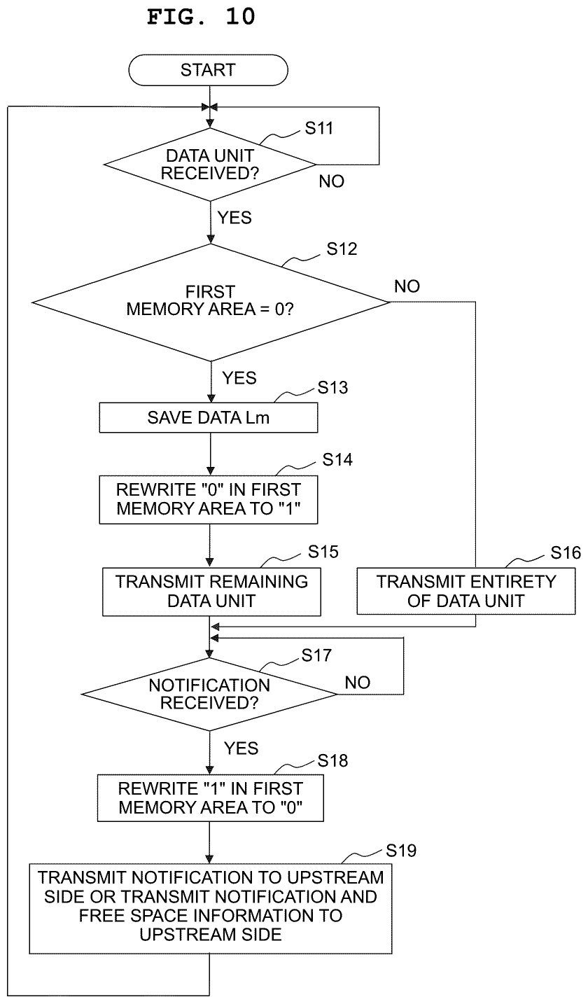

FIG. 10 is a flow chart illustrating the data transmitting process by the control part 41a of each of the sub-control circuits 41(1) to 41(8) other than the downstream-most sub-control circuit 41(9). The control part 41a determines whether a data unit of the mth line has been received from the upstream side (step S11). In a case where the control part 41a determines that the data unit of the mth line has not been received (step S11: NO), the control part 41a returns the process to the step S11. In a case where the control part 41a determines that the data unit of the mth line has been received (step S11: YES), the control part 41a determines whether “0” is stored in the first memory area 45a (step S12).

In a case where the control part 41a determines that “0” is stored in the first memory area 45a (step S12: YES), the control part 41a saves the data, in the mth line, corresponding to the self, i.e., the data Lm (step S13), and rewrites the data stored in the first memory area 45a from “0” to “1” (step S14). The control part 41a transmits, to the downstream side, the remaining data unit excluding the data Lm (step S15). The control part 41a determines whether the notification indicating that the data stored in the first memory area 45a is to be rewritten from “1” to “0” has been received from the downstream side (step S17).

In a case where the control part 41a determines that the notification has not been received (step S17: NO), the control part 41a returns the process to the step S17. In a case where the control part 41b determines that the notification has been received (step S17: YES), the control part 41a rewrites the information stored in the first memory area 45a from “1” to “O” (step S18) and transmits, to the upstream side, the notification indicating that the information stored in the first memory area 45a is to be rewritten from “1” to “0”, or the control part 41a transmits, to the upstream side, the notification indicating that the information stored in the first memory area 45a is to be rewritten from “1” to “0” and the free space information of the second memory area 45b in its own sub-control circuit 41 (step S19). The control part 41a of the upstream-most sub-control circuit 41(1) transmits the notification and the free space information to the main control circuit 7a on the upstream side, whereas the control part 41a of each of the sub-control circuits 41(2) to 41(8) other than the upstream-most sub-control circuit 41(1) transmits the notification to the sub-control circuit 41 on the upstream side. The control part 41a returns the process to the step S11.

In the step S12, in a case where the control part 41a determines that “0” is not stored in the first memory area 45a (step S12: NO), that is, in a case where the control part 41a determines that “1” is stored, the control part 41a transmits the entirety of the data unit to the downstream side, without saving the data (step S16), and the control part 41a advances the process to the step S17.

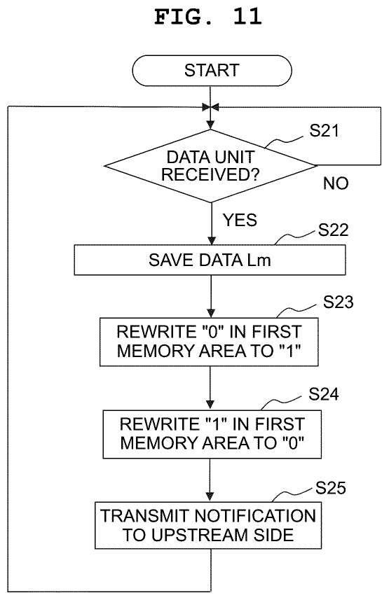

FIG. 11 is a flow chart illustrating the data transmitting process by the control part 41a of the downstream-most sub-control circuit 41(9). In the initial state, “0” is stored in the first memory area 45a of the sub-control circuit 41(9).

The control part 41a determines whether the data unit of the mth line has been received from the upstream side (step S21). In a case where the control part 41a determines that the data unit of the mth line has not been received (step S21: NO), the control part 41a returns the process to the step S21. In a case where the control part 41a determines that the data unit has been received (step S21: YES), the control part 41a saves the data, in the mth line, corresponding to the self, that is, the data Lm (step S22), and rewrites the information stored in the first memory area 45a from “0” to “1” (step S23). The control part 41a rewrites the information stored in the first memory area 45a from “1” to “O” (step S24), transmits, to the upstream side, the notification indicating that the information stored in the first memory area 45a is to be rewritten from “1” to “0” (step S25), and returns the process to the step S21. Note that the control part 41a of the sub-control circuit 41(9) may not execute the processes of steps S23 and S24.

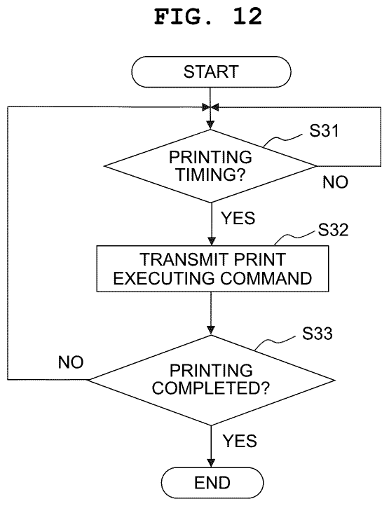

FIG. 12 is a flow chart illustrating the printing process by the control part 7b of the main control circuit 7a. The control part 7b determines whether a printing timing has arrived (step S31). In a case where the control part 7b determines that the printing timing has not arrived (step S31: NO), the control part 7b returns the process to the step S31. In a case where the control part 7b determines that the printing timing has arrived (step S31: YES), the control part 7b transmits the print executing command to the sub-control circuit 41(1) (step S32). The print executing command is transferred down to the downstream-most sub-control circuit 41(9). Each of the sub-control circuit 41(1) to the sub-control circuit 41(9) transmits the print data to the head 42 and executes the printing. Each of the sub-control circuit 41(1) to the sub-control circuit 41(9) deletes the print data, based on which the printing has been executed, from the own second memory area 45b.

The control part 7b determines whether the printing has been completed (step S33). For example, in a case where the control part 7b has received a notification indicating that the printing has been completed from the sub-control circuit 41(1) to the sub-control circuit 41(9) regarding all of the print data received from the external apparatus 9, or in a case where a print stop signal is input from a print stop switch, the control part 7b determines that the printing has been completed. In a case where the control part 7b determines that the printing has not been completed (step S33: NO), the control part 7b returns the process to the step S31. In a case where the control part 7b determines that the printing has been completed (step S33: YES), the control part 7b ends the process.

In the printing apparatus 1 according to the first embodiment, the information indicating the transmitting method of the print data is stored in the first memory area 45a of the sub-control circuit 41, and in a case where the sub-control circuit 41 receives the print data, the sub-control circuit 41 transmits the print data downstream according to the transmitting method indicated by the information. For example, in a case where the information indicates the method of transmitting print data without storing the print data and where the sub-control circuit 41 receives the print data from the upstream side, the sub-control circuit 41 transmits the print data downstream, without storing the print data in the own second memory area 45b. Thus, the decrease in efficiency of the transmitting process of the print data can be suppressed. Further, since the sub-control circuit 41 transmits the print data without storing the print data, the capacity of the main memory 41b can be reduced, and the cost of the parts constructing the main memory 41b can be reduced.

Note that the main control circuit 7a may generate and transmit three or more data units in the steps S2 and S3 (see FIG. 9). For example, the main control circuit 7a may generate and transmit a first data unit including the data D1 to the data D3, a data unit including the data D4 to the data D6 (hereinafter referred to as a “second data unit (1st)”), and a data unit including the data D7 to the data D9 (hereinafter referred to as a “second data unit (2nd)”). The main control circuit 7a may generate and transmit the second data unit (1st) after generating and transmitting the first data unit; and the main control circuit 7a may generate and transmit the second data unit (2nd) after generating and transmitting the second data unit (1st).

In this case, the second data unit (1st) is a data unit generated from remaining print data obtained by excluding the generated data unit (first data unit) from the print data of one line, and includes the data D4 which is the upstream-most of the remaining print data. The data D4 corresponds to the sth data. The second data unit (2nd) is a data unit generated from remaining print data obtained by excluding the generated data units (first data unit and second data unit (1st)) from the print data of one line, and includes the data D7 which is the upstream-most of the remaining print data. The data D7 corresponds to the sth data.

That is, in the step S2 (see FIG. 9), in a case where the main control circuit 7a generates three or more data units, the main control circuit 7a repeats the generation of the data unit including the upstream-most data of the remaining print data, that is, the second data unit, from the remaining print data in which the generated data unit has been excluded from the print data of one line, after the generating process of the first data unit. In a case where each of the sub-control circuits 41 receives the data unit such as the first data unit, the second data unit (1st), or the second data unit (2nd), and where the information stored in the own first memory area 45a is “0” as described above, each of the sub-control circuits 41 saves the data corresponding to the self in the own second memory area 45b, reads the data unit excluding the data corresponding to the self from the own second memory area 45b, transmits the data unit excluding the data corresponding to the self to the downstream side, and deletes the data unit excluding the data corresponding to the self from the own second memory area 45b. Further, each of the sub-control circuits 41 rewrites the information stored in the own first memory area 45a from “0” to “1”. On the other hand, in a case where each of the sub-control circuits 41 receive a data unit and where the information stored in the own first memory area 45a is “1”, each of the sub-control circuits 41 transmits, to the downstream side, the entirety of the data unit which has been received and deletes, from the own second memory area 45b, the entirety of the data unit which has been received.

Note that in a case where the size of the free space of the second memory area 45b of the sub-control circuit 41(1) is the prescribed size or more, the main control circuit 7a changes the data amount of each of the data units (first data unit and second data unit), i.e., the main control circuit 7a increases the data amount, within a range that the data amount of each of the data units does not exceed the size of the free space of the second memory area 45b, and transmits the print data of the next line to the downstream side. Examples of the method of making the data amount great include a method of not dividing the data or a method of making the number by which the data is divided small.

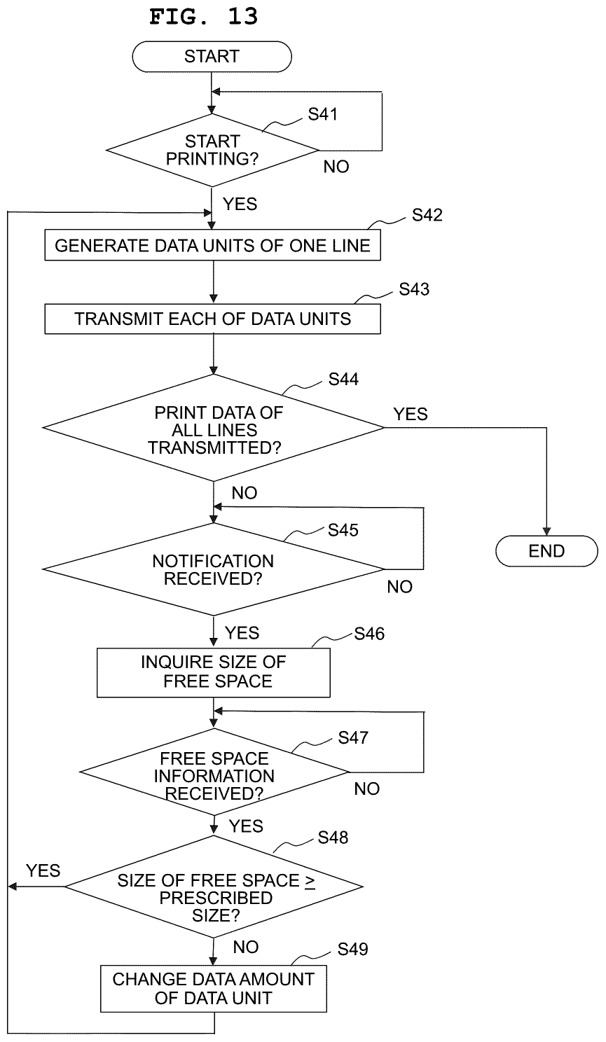

In the following, the present disclosure will be described based on the drawings depicting a printing apparatus according to a second embodiment. Among the configurations of a printing apparatus 1 according to the second embodiment, a configuration which is same as or similar to the configuration of the first embodiment is designated by the same reference numeral, and any detailed description thereof will be omitted. In the first embodiment, the control part 7b determines whether the free size information of the second memory area 45b of the sub-control circuit 41(1) has been received, whereas in the second embodiment, the control part 7b inquires of the sub-control circuit 41(1) about the size of the free space of the second memory area 45b. FIG. 13 is a flowchart illustrating a data transmitting process by the main control circuit 7a. Since the process in the steps S41 to S44, S48, and S49 in FIG. 13 are same as or similar to the process in the steps S1 to S4, S6, and S7 in FIG. 9, the detailed description thereof will be omitted. Here, process of the steps S45 to S47 will be mainly described.

In the step S44, in a case where the control part 7b determines that the print data of all the lines has not been transmitted (step S44: NO), the control part 7b determines whether the notification indicating that the information stored in the first memory area 45a is to be rewritten from “1” to “0” has been received (step S45). In a case where the control part 7b determines that the notification has not been received (step S45: NO), the control part 7b returns the process to the step S45.

In a case where the control part 7b determines that the notification has been received (step S45: YES), the control part 7b inquires of the upstream-most sub-control circuit 41(1) about the size of the free space of the second memory area 45b (step S46). The control part 7b determines whether the information (the free space information) indicating the size of the free space of the sub-control circuit 41(1) has been received (step S47). In a case where the control part 7b determines that the free space information of the sub-control circuit 41(1) has not been received (step S47: NO), the control part 7b returns the process to the step S47. In a case where the control part 7b determines that the free space information of the sub-control circuit 41(1) has been received (step S47: YES), the control part 7b advances the process to the step S48.

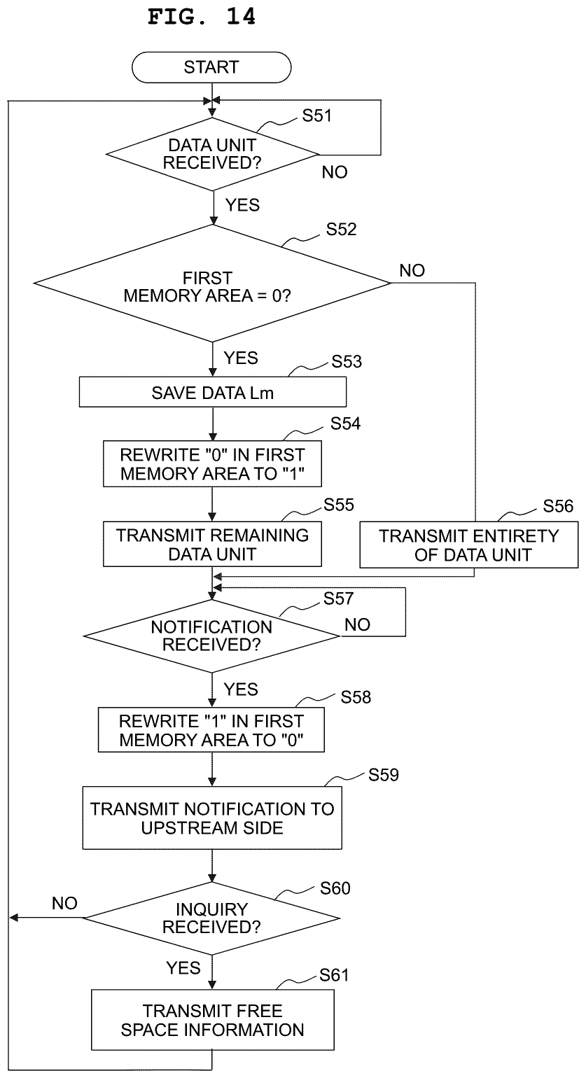

FIG. 14 is a flow chart illustrating a data transmitting process by the control part 41a of each of the sub-control circuit 41(1) to the sub-control circuit 41(8) other than the downstream-most sub-control circuit 41(9). Since the steps S51 to S58 in FIG. 14 are same as or similar to the steps S11 to S18 in FIG. 10, any detailed description thereof is omitted. Here, a process of the steps S59 to S61 is mainly described.

The control part 41a transmits the notification indicating that the information stored in the first memory area 45a is to be rewritten from “1” to “0” to the upstream side (step S59). The control part 41a determines whether an inquiry about the size of the free space of the second memory area 45b has been received from the main control circuit 7a (step S60). In a case where the control part 41a determines that the inquiry has not been received (step S60: NO), the control part 41a returns the process to the step S51. Note that each of the sub-control circuits 41(2) to 41(8) does not receive the inquiry from the main control circuit 7a.

In a case where the control part 41a determines that the inquiry has been received (step S60: YES), the control part 41a transmits the free space information to the main control circuit 7a (step S61) and returns the process to the step S51. In a case where the sub-control circuit 41(1) receives the inquiry from the main control circuit 7a, the control part 41a transmits the free space information to the main control circuit 7a.

Note that, in the above embodiment, for example in the step S19 of FIG. 10 or in the step S61 of FIG. 14, the sub-control circuit 41(1) may transmit information indicating a size of a used space of the second memory area 45b of the sub-control circuit 41(1) instead of the free space information. The main control circuit 7a may calculate the size of the free space of the second memory area 45b of the sub-control circuit 41(1) based on a capacity of the second memory area 45b of the sub-control circuit 41(1) and the information indicating the size of the used space of the second memory area 45b of the sub-control circuit 41(1). Information indicating a size of a free space of a memory and information indicating a size of a used space of a memory are each an example of “information regarding a size of a free space of a memory”.

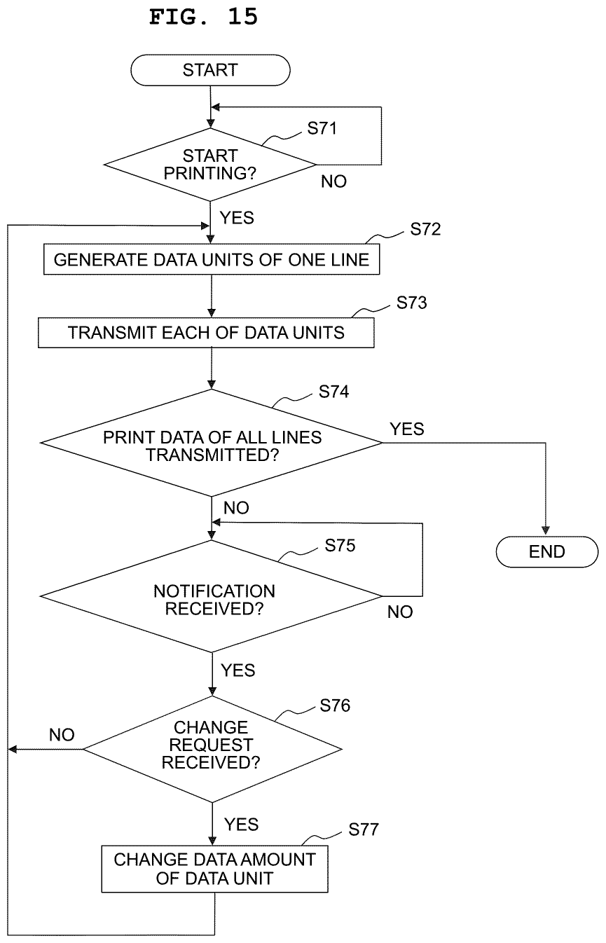

In the following, the present disclosure will be described based on the drawings depicting a printing apparatus according to a third embodiment. Among the configurations of a printing apparatus 1 according to the third embodiment, a configuration which is same as or similar to the configuration of the first embodiment or the second embodiment is designated by the same reference numeral, and any detailed description thereof will be omitted. In the first embodiment, the control part 7b determines whether the free space information of the second memory area 45b of the sub-control circuit 41(1) has been received, whereas in the third embodiment, the control part 7b determines whether a change request of changing the data amount of the data unit has been received from the sub-control circuit 41(1). FIG. 15 is a flow chart illustrating a data transmitting process by the main control circuit 7a. Since the process of the steps S71 to S75 in FIG. 15 is same as or similar to the process of the steps S41 to S45 in FIG. 13, any detailed descriptions thereof are omitted. Here, a process of the steps S76 and S77 will be mainly described.

In a case where the control part 7b receives the notification indicating that the information stored in the first memory area 45a is to be rewritten from “1” to “0” (step S75: YES), the control part 7b determines whether the change request of changing the data amount of the data unit has been received from the sub-control circuit 41(1) (step S76). In a case where the control part 7b determines that the change request has not been received (step S76: NO), the control part 7b returns the process to the step S72. In a case where the control part 7b determines that the change request has been received (step S76: YES), the control part 7b changes the data amount of the data unit (step S77) and returns the process to the step S72.

As will be described later, in a case where the size of the free space of the second memory area 45b in any sub-control circuit 41 among the sub-control circuits 41 becomes equal to or smaller than the data amount of the data unit, said sub-control circuit 41 transmits the change request to the upstream side. The change request is transferred up to the main control circuit 7a. The control part 7b changes the data amount of the data unit so that the data amount of the data unit becomes sufficiently smaller than the size of the free space of the second memory area 45b of said sub-control circuit 41. For example, in a case where the main control circuit 7a receives the change request after transmitting the first data unit including the data D1 to the data D5, then in the steps S72 and S73, the main control circuit 7a generates and transmits a second data unit including data D6 and data D7, and a third data unit including data D8 and data D9. Note that the main control circuit 7a may generate and transmit three or more data units.

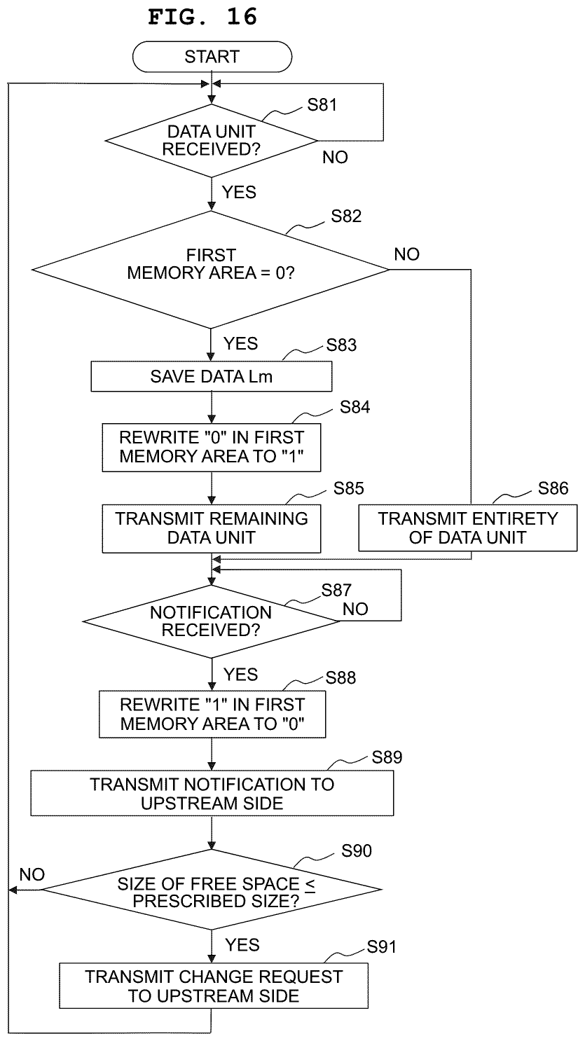

FIG. 16 is a flow chart illustrating a data transmitting process by the control part 41a of each of the sub-control circuits 41(1) to the sub-control circuit 41(8) other than the downstream-most sub-control circuit 41(9). Since the process of the steps S81 to S89 in FIG. 16 is same as or similar to the process of the steps S51 to S59 in FIG. 14, any detailed description thereof is omitted. Here, the process of the steps S90 and S91 is mainly described.

The control part 41a determines whether the size of the free space of the second memory area 45b in the own sub-control circuit 41 is a prescribed size or less (step S90). The prescribed size is, for example, a prescribed multiple of the data amount of the data unit. For example, the prescribed size is “r” times the data amount of the data unit. The “r” is a value which is 1 or more, for example, 1.05 or more. In a case where the control part 41a determines that the size of the free space is not the prescribed size or less (step S90: NO), the control part 41a returns the process to the step S81. In a case where the control part 41a determines that the size of the free space is the prescribed size or less (step S90: YES), the control part 41a transmits a change request of changing the data amount of the data unit to the upstream side (step S91) and returns the process to the step S81. In a case where each of the sub-control circuits 41 receives the change request from the downstream side, the sub-control circuits 41 transfer the change request up to the main control circuit 7a.

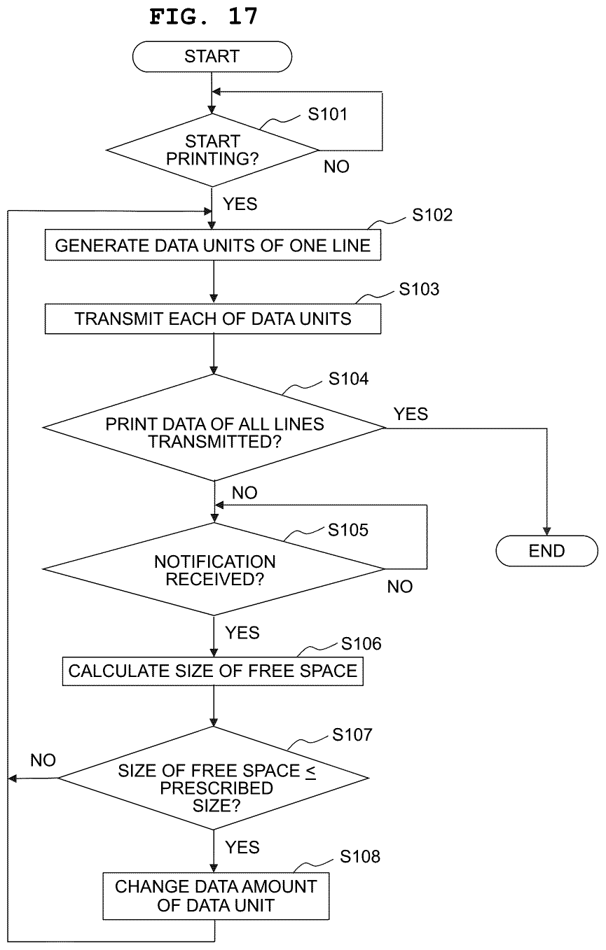

In the following, the present disclosure will be described based on the drawings depicting a printing apparatus according to a fourth embodiment. Among the configurations of a printing apparatus 1 according to the fourth embodiment, a configuration which is same as or similar to the configuration of each of the first to third embodiments is designated by the same reference numeral, and any detailed description thereof will be omitted. In the first embodiment, the control part 7b determines whether the free space information of the second memory area 45b of the sub-control circuit 41 (1) has been received, whereas in the fourth embodiment, the control part 7b calculates the size of the free space in the second memory areas 45b of the respective sub-control circuits 41, and determines whether the minimum size among the sizes of the free spaces in the second memory areas 45b of the respective sub-control circuits 41 is a prescribed size or less. FIG. 17 is a flowchart illustrating a data transmitting process by the main control circuit 7a. Since the process of the steps S101 to S105 in FIG. 17 are same as or similar to the process of the steps S41 to S45 in FIG. 13, any detailed description thereof will be omitted. Here, a process of the steps S106 to S108 will be mainly described.

In a case where the control part 7b receives a notification indicating that the information stored in the first memory area 45a is to be rewritten from “1” to “0” (step S105: YES), the control part 7b calculates the sizes of the free spaces in the second memory areas 45b of the respective sub-control circuits 41 (step S106). The storage capacity of the second memory area 45b of each of the sub-control circuits 41 is stored in advance in the auxiliary memory 7d. The control part 7b calculates the size of the free space in the second memory area 45b of each of the sub-control circuits 41, based on a data amount of the print data transmitted from the main control circuit 7a to the downstream side and a data amount of the print data for which the printing has been performed by the print executing command and which has been deleted from the second memory area 45b of each of the sub-control circuits 41.

The control part 7b determines whether or not the minimum size among the sizes of the free spaces in the second memory areas 45b of the respective sub-control circuits 41 is a prescribed size or less (step S107). The prescribed size is, for example, a prescribed multiple of the data amount of the data unit. For example, the prescribed size is “t” times the data amount of the data unit. The “t” is a value which is 1 or more, for example, 1.5 or more. In a case where the control part 7b determines that the minimum size is not the prescribed size or less (step S107: NO), the control part 7b returns the process to the step S102. In a case where the control part 7b determines that the minimum size is the prescribed size or less (step S107: YES), the control part 7b changes the data amount of the data unit (step S108) and returns the process to the step S102.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

Note that the computer program can be developed to be executed on a single computer, or on a plurality of computers which are disposed in one site or distributed over a plurality of sites and which are interconnected by a communication network.

The main control circuit 7a may include a plurality of control parts 7b. The main control circuit 7a may perform a distributed process of one process by using the plurality of control parts 7b, or may perform a parallel process of a plurality of processes by using the plurality of control parts 7b. The sub-control circuit 41 may include a plurality of control parts 41a. The sub-control circuit 41 may perform a distributed process of one process by using the plurality of control parts 41a, or may perform a parallel process of a plurality of processes by using the plurality of control parts 41a.

The embodiments disclosed herein are examples in all senses and should not be interpreted as limiting. The scope of the present disclosure is intended to encompass all the changes within the scope of the claims and a scope equivalent to the scope of the claims. The matters described in the respective embodiments can be combined with each other. Further, the independent claims and dependent claims described in the claims can be combined with each other in any and all combinations, regardless of the form of reference therebetween.

What is claimed is:

1. A printing apparatus comprising:
a main control circuit; and
a plurality of sub-control circuits which is connected in series to each other and which is configured to transmit print data transmitted from the main control circuit downstream, the plurality of sub-control circuits including at least a downstream-most sub-control circuit positioned on a downstream-most side among the plurality of sub-control circuits and an upstream-most sub-control circuit positioned on an upstream-most side among the plurality of sub-control circuits and connected to the main control circuit,
wherein each of at least one sub-control circuit, which is included in the plurality of sub-control circuits and which is other than the downstream-most sub-control circuit is configured to:
store information indicating one of a plurality of transmitting methods of the print data, the plurality of transmitting methods including a transmitting method by which the one of the plurality of sub-control circuits having received the print data transmits entirety of the print data received downstream; and
transmit the print data downstream, by the one of the plurality of transmitting methods indicated by the information, in a case where the print data is received.

2. The printing apparatus according to claim 1, wherein:
the print data includes a plurality of parts corresponding to the plurality of sub-control circuits, respectively;
the information is first information indicating a first transmitting method by which one of the plurality of sub-control circuits having received the print data saves corresponding data which is one of the plurality of parts, of the print data received, corresponding to self and transmits the print data from which the corresponding data has been excluded downstream, or second information indicating a second transmitting method being the transmitting method by which the one of the plurality of sub-control circuits having received the print data transmits the entirety of the print data received downstream;
the main control circuit is configured to execute a transmitting process of transmitting, to the upstream-most sub-control circuit, the plurality of parts of the print data;
in an initial state, the information stored in the upstream-most sub-control circuit is the first information; and
in a case where the upstream-most sub-control circuit receives the print data, the upstream-most sub-control circuit is configured to save the corresponding data, then transmit the print data from which the corresponding data has been excluded downstream, and rewrite the information stored in the upstream-most sub-control circuit to the second information.

3. The printing apparatus according to claim 2, wherein the main control circuit is configured to transmit the plurality of parts of the print data to the upstream-most sub-control circuit starting from a part, of the print data, corresponding to the upstream-most sub-control circuit.

4. The printing apparatus according to claim 2, wherein:
the plurality of sub-control circuits includes at least one intermediate sub-control circuit positioned between the upstream-most sub-control circuit and the downstream-most sub-control circuit;
in the initial state, information stored in each of the at least one intermediate sub-control circuit is the first information; and
in a case where each of the at least one intermediate sub-control circuit receives the print data, each of the at least one intermediate sub-control circuit is configured to store the corresponding data, then transmit the print data from which the corresponding data has been excluded downstream, and rewrite the information stored in self to the second information.

5. The printing apparatus according to claim 2, wherein in a case where the information stored in the upstream-most sub-control circuit is the second information, and where the upstream-most sub-control circuit receives the print data, the upstream-most sub-control circuit is configured to transmit the entirety of the print data received downstream without saving the print data received.

6. The printing apparatus according to claim 4, wherein in a case where the information stored in one of the upstream-most sub-control circuit and the at least one intermediate sub-control circuit is the second information, and where the one of the upstream-most sub-control circuit and the at least one intermediate sub-control circuit receives the print data, the one of the upstream-most sub-control circuit and the at least one intermediate sub-control circuit is configured to transmit the entirety of the print data received downstream without saving the print data received.

7. The printing apparatus according to claim 2, wherein the main control circuit is configured to execute:
a first generating process of generating, from the print data, a first data unit including at least one of the plurality of parts of the image data including the part corresponding to the upstream-most sub-control circuit;
a second generating process of generating, from remaining print data, a second data unit including at least one of the plurality of parts of the image data including a part corresponding to a sub-control circuit positioned upstream-most among the plurality of sub-control circuits corresponding to the parts of the print data included in the remaining print data, the remaining print data being data obtained by excluding parts included in a data unit, of the first data unit and the second data unit, having been generated from the print data;
a first transmitting process of transmitting the first data unit generated to the upstream-most sub-control circuit; and
a second transmitting process of transmitting the second data unit generated to the upstream-most sub-control circuit; and
the main control circuit is configured to execute the second transmitting process after executing the first transmitting process, in the transmitting process.

8. The printing apparatus according to claim 7, wherein the main control circuit is configured to repeat the second generating process after executing the first generating process.

9. The printing apparatus according to claim 7, wherein:
the upstream-most sub-control circuit includes a memory; and
the main control circuit is configured to determine a data amount of each of the first data unit and the second data unit based on a size of a free space in the memory.

10. The printing apparatus according to claim 9, wherein the main control circuit is configured to obtain information regarding the size of the free space of the memory from the upstream-most sub-control circuit.

11. The printing apparatus according to claim 7, wherein:
the upstream-most sub-control circuit includes a memory; and
the main control circuit is configured to change a data amount of each of the first data unit and the second data unit based on a capacity of the memory and an amount of data transmitted to the upstream-most sub-control circuit.

12. The printing apparatus according to claim 2, further comprising a plurality of heads corresponding to the plurality of sub-control circuits, respectively, wherein:
the upstream-most sub-control circuit includes a common memory area configured to store the corresponding data and the print data from which the corresponding data has been excluded; and
the upstream-most sub-control circuit is configured to read out the corresponding data from the common memory area, transmit the corresponding data to a head, of the plurality of heads, corresponding to the upstream-most sub-control circuit, and read out, from the common memory area, the print data from which the corresponding data has been excluded, and transmit the print data from which the corresponding data has been excluded downstream.

13. The printing apparatus according to claim 4, further comprising a plurality of heads corresponding to the plurality of sub-control circuits, respectively, wherein:
each of the upstream-most sub-control circuit and the at least one intermediate sub-control circuit includes a common memory area configured to store the corresponding data and the print data from which the corresponding data has been excluded; and
each of the upstream-most sub-control circuit and the at least one intermediate sub-control circuit is configured to read out the corresponding data from the common memory area, transmit the corresponding data to a head, of the plurality of heads, corresponding to self, read out, from the common memory area, the print data from which the corresponding data has been excluded, and transmit the print data from which the corresponding data has been excluded downstream.

14. The printing apparatus according to claim 1, wherein the downstream-most sub-control circuit is configured to instruct the at least one sub-control circuit other than the downstream-most sub-control circuit to rewrite the information to the first information, based on reception of the print data.

15. A printing method executed in a printing apparatus,
the printing apparatus including:
a main control circuit; and
a plurality of sub-control circuits which is connected in series to each other and which is configured to transmit print data transmitted from the main control circuit downstream, the plurality of sub-control circuits including at least a downstream-most sub-control circuit positioned on a downstream-most side among the plurality of sub-control circuits and an upstream-most sub-control circuit positioned on an upstream-most side among the plurality of sub-control circuits and connected to the main control circuit;
the printing method comprising causing each of at least one sub-control circuit, which is included in the plurality of sub-control circuits and which is other than the downstream-most sub-control circuit to:
store information indicating one of the plurality of transmitting methods of the print data, the plurality of transmitting methods including a transmitting method by which the one of the plurality of sub-control circuits having received the print data transmits entirety of the print data received downstream; and
transmit the print data downstream, by the one of the plurality of transmitting methods indicated by the information, in a case where the print data is received.

16. A non-transitory and computer-readable medium storing a program executable by a plurality of sub-control circuits of a printing apparatus,
the printing apparatus including:
a main control circuit; and
the plurality of sub-control circuits which is connected in series to each other and which is configured to transmit print data transmitted from the main control circuit downstream, the plurality of sub-control circuits including at least a downstream-most sub-control circuit positioned on a downstream-most side among the plurality of sub-control circuits and an upstream-most sub-control circuit positioned on an upstream-most side among the plurality of sub-control circuits and connected to the main control circuit;
the program is configured to cause each of at least one sub-control circuit, which is included in the plurality of sub-control circuits and which is other than the downstream-most sub-control circuit to execute:
storing of information indicating one of a plurality of transmitting methods of the print data, the plurality of transmitting methods including a transmitting method by which the one of the plurality of sub-control circuits having received the print data transmits entirety of the print data received downstream; and
transmitting of the print data downstream, by the one of the plurality of transmitting methods indicated by the information, in a case where the print data is received.
